(19) United States
(12) Patent Application Publication
(10) Pub. No.: US 2008/0090212 A1
(43) Pub. Date: Apr. 17, 2008

(54) Mathematics teaching tool

(76) Inventor: Adam J. Teather, Round Lake Beach, IL (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/548,854

(22) Filed: Oct. 12, 2006

(51) Int. Cl. G09B 19/02

(52) U.S. Cl. 434/188

(57) ABSTRACT

A tool for teaching numbers and mathematics comprises a 10 by 10 array of cells containing the numbers 00 to 99 in two digit form, increasing in serial order from the lower left of the array, a set of symbols each uniquely associated with one of the prime numbers from 02 to at least 13 and a symbol associated with any other prime number. Each cell containing a non-prime number shows a combination of the symbols associated with the factors of the non-prime number. This aids in teaching addition, subtraction, multiplication, and division. The tool also represents part of the Cartesian coordinate plane which makes it useful for teaching algebra and geometry.

### FIELD OF INVENTION

The present invention is a tool that relates to teaching methods for mathematics, and in particular it is an aid to students for understanding numbers and mathematical operations and developing number sense.

### BACKGROUND OF THE INVENTION

Some previously-known teaching aids make use of a ten-by-ten (1-100) chart, with numbers increasing by rows from top-left to bottom-right. Less common, but known in the art, is the use of a ten-by-ten (0-99) chart, which I have found gives students a better starting point for their study of relationships between numbers than the 1-100 chart. This 0-99 chart lists numbers increasing by rows from top-left to bottom-right. An improvement on this is to write all numbers with two digits. Just as building understanding of the digits 0 through 9, as the only ten digits in our decimal counting system, reinforces the concept of place value, so too does 00-99 further reinforce the concepts of ones and tens place value.

The present invention takes this number structure to the next level of connections. By taking the ten-by-ten (0-99) chart and rotating it counter-clockwise 90 degrees around the middle of the grid, this new tool maximize connections. With two-digit numbers (00-99) in each cell of the ten-by-ten grid, increasing column by column from bottom-left to top-right, students are asked to “count up” and move over to the right when it is time to change the tens digit. Number values are increasing by one when moving up, and by 10 when moving to the right, instead of the traditional +10 by moving downward and +1 by moving to the right. In this layout, 14 is above 13; 12 is below 13; 03 is to the left of 13; 23 is to the right of 13. The use of two-digit numbers for all numbers up to 100 reinforces place value and builds a foundation for making connections between number patterns and all other concepts.

The National Council of Teachers of Mathematics (“NCTM”) has set out principles and standards for teaching mathematics, part of which is that all the mathematics for pre-kindergarten through grade 12 is strongly grounded in number. The present invention is in accordance with the NCTM principles and standards, and reflects the importance of connections as the pathway to mathematical enlightenment. Mathematics is an integrated field of study. Viewing mathematics as a whole highlights the need for studying and thinking about the connections within the discipline, as reflected both within the curriculum of a particular grade and between grade levels.

The tool embodying the present invention is intended to be used by students beginning as early as Kindergarten, and it can be used through grade 10 and beyond. It encourages students to explore and construct their own learning through pattern recognition. It provides students with opportunities to connect different mathematical concepts by embedding multiple representations in a novel design which can be printed on, but is not limited to, the surface of a whiteboard. Using either a whiteboard marker, transparent chips, or opaque chips, students can be guided through pattern explorations, discoveries and investigations, which serve to build conceptual understanding through solidifying relationships between mathematical ideas.

The tool embodying the present invention can assist elementary and secondary teachers in engaging students in deepening their understanding of mathematics through the investigation of patterns and the connection of concepts. Students are encouraged to explore patterns of numbers, symbols and placement of these to foster improved understanding of concepts. The study of relationships between numbers and number systems along with an awareness of the relationships between number and other strands is important to attain a deeper understanding of mathematics. By using the Cartesian plane, the present invention can be used to develop awareness of relationships between numbers and number systems, as well as inverse operations. In using prime numbers as the basis for the symbolic representation of each two-digit number, students' awareness of number types and patterns will be significantly enhanced. The invention provides students access to mathematical facts that traditionally required memorization, either as a reinforcement tool or as a temporary crutch which can be used to build connections to something students can understand more easily.

### SUMMARY OF THE INVENTION

The present invention provides a tool for teaching numbers and mathematics, comprising, first, a printed array of the numbers 00 to 99, in two digit form, each in one of the one hundred cells of an array of ten by ten square cells, with said numbers increasing in serial order from 00 in the lower left of the array up the leftmost column to 09 at the top of that leftmost column, and continuing in the next column to the right with the number 10 at the bottom of that column, and so on in serial order until the number 99 in the top rightmost cell of the array; second, a set of symbols, each one of which is uniquely associated with one of the prime numbers from 02 to at least 13; third, an additional single symbol that is non-uniquely associated with any prime number that does not have a symbol otherwise associated with it; and fourth, combinations of said symbols, each combination being uniquely associated with a non-prime number by appearing in the cell containing said non-prime number, said combination consisting of the symbols associated with the numbers that are all the factors of said non-prime number.

### BRIEF DESCRIPTION OF THE DRAWINGS

FIG. 1 is a top plan view of the preferred embodiment of the invention, as expressed on a whiteboard. The drawing does not have reference numbers, as each cell has its own number that can be used to identify the features of the invention.

### DETAILED DESCRIPTION OF THE PREFERRED EMBODIMENT

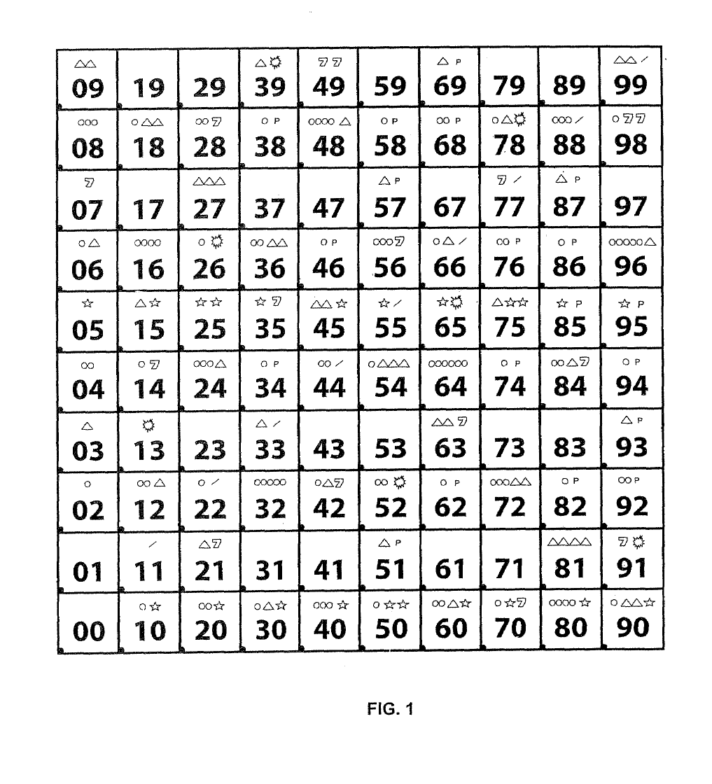

As shown in FIG. 1, a sheet is laid out with one hundred square cells in a ten by ten array of cells. Preferably the sheet is made of stiff material that is not easily damaged, such as whiteboard. It is further preferable if the sheet or whiteboard can take students' writing that is easily erased, such as writing with a dry-erase marker. It is also preferable to have a margin around the array sufficient for students to write notes, and possible to write in at least one more column and one more row. There are five main elements of the design of each of the cells and their contents.

First, each cell has a two-digit number. Even a single digit number, such as 7, is represented by 07. The two digits, if imagined separated by a comma, are Cartesian coordinates. For example, 34 can be thought of as the coordinate (3,4).

Second, each cell is one inch by one inch exactly, yielding an area of one square inch. The area of the entire design is one hundred square inches, presenting an opportunity to connect one and two-dimensional measurement with the study of percents, fractions, and decimals. Students will also become more aware of estimating distances between one inch and ten inches. For students who work in the metric system, a cell of two centimetres by two centimetres would be appropriate, as a one centimetre cell is inconveniently small, although one centimetre cells are within the scope of the present invention. However, the cells can be any other uniform size in an embodiment that achieves all the other benefits of this invention except the facilitation of measurement.

Third, each cell has a coordinate point located in the bottom left corner. It will be called here a COORDINATE DOT. In the Cartesian plane, this point is the exact location referenced by the number in the same cell. By identifying this specific point on any cell along the edge of the array, students can accurately represent and understand one-dimensional (linear) measurements. By identifying this specific point on any cell in the array, students can accurately find a two-dimensional (Cartesian) representation of a position.

Fourth, the cells, except cells for the prime numbers 17 and higher, have a symbolic representation of that number inside the cell. The numbers 00 and 01 are not called “prime”. There was a need to give students sufficient visual (symbolic) information, but not so much as to clutter the board, so there are only seven distinct symbols. There are six symbols representing the first six prime numbers, 2, 3, 5, 7, 11, and 13. In FIG. 1, the cells with those numbers show the associated symbols. The symbols in each cell represent a number's prime factorization, with the number 01 always understood to be a factor. Prime numbers, except the first six prime numbers, have no symbol in their cell. For certain numbers that have a prime number as a factor, beginning with number 34, the letter “P” represents the prime number that does not otherwise have a symbol. “P” can stand for any prime number. In the factors of number 34, “P” stands for the number 17. In the factors of number 38, “P” stands for the number 19. An added benefit of having only seven symbols is that it encourages students to use mental math to determine the exact value of “P” as a factor for a particular number.

Fifth, the symbols in the preferred embodiment were each chosen to have a meaning that logically relates to what they represent, although this meaningful symbolism is not an essential part of the invention. This is intended to provide a visual image of the number represented by the symbol.

The circle was chosen as the symbol to represent the number 02 because it has an inside and an outside, which can be thought of as two sides. It will be called here CIRCLE, and is shown in FIG. 1 in the cell marked 02.

The equilateral triangle is the symbol to represent the number 03 because there are three sides, three corners, three congruent angles, three vertices, three lines of symmetry, and three axes of rotational symmetry. It will be called here TRIANGLE, and is shown in FIG. 1 in the cell marked 03.

The five-pointed star is the symbol to represent the number 05 because it is easily recognizable as having five points. It will be called here STAR, and is shown in FIG. 1 in the cell marked 05.

The heptagon is a seven-sided figure chosen as the symbol to represent the number 07. The sides are drawn in a way that makes the final image look like the number seven, which helps reinforce the concept that this is the symbol for that prime number. It will be called here HEPTA, and is shown in FIG. 1 in the cell marked 07

A diagonal line from bottom left to top right is the symbol to represent the number 11. This diagonal line is intended to serve as a visual reminder and reinforce the idea that all the multiples of 11 appear on a diagonal line from the bottom left to the top right. It will be called here SLASH, and is shown in FIG. 1 in the cell marked 11.

A thirteen-pointed star is the symbol to represent the number 13. This star is distinctly different from the five-pointed star, so there should be no confusion between the two symbols. It will be called here BLAST, and is shown in FIG. 1 in the cell marked 13.

The letter “P” is the symbol to represent any prime number larger than 13, which on the 00-99 board will be 17, 19, 23, 29, 31, 37, 41, 43, and 47. The letter “P” was chosen to reinforce the vocabulary of mathematics, recalling the word “prime”. An example is shown in FIG. 1 in the cell marked 38.

In an alternate embodiment of the invention, the symbols could each have a different colour associated with them. This would catch the eyes of the students more quickly, as they search the board for the symbols needed to solve a problem. The students can add the colour themselves as an aid to initially becoming familiar with the invention.

In yet another alternate embodiment of the invention, the symbols could be distinguished by colour only, and might be any regular geometric figure.

In the preferred embodiment of the invention, the numbers in the chart run upwards in columns starting from the lower left. Numbers increase as they move upward, and that is consistent with common experience that an increase is a move upward. For example, mercury moves UP the thermometer as temperature increases. Common language is to “count UP the number of objects”. Numbers increase as they move from left to right, as does writing in the English language.

An alternate embodiment would have the array laid out with one hundred numbers increasing in serial order from left to right along the first row of ten cells, and continuing the serial order from left to right in the second row of ten cells. The numbers increase by one unit progressing from one cell to the adjacent cell, where adjacent means the cells touch along their sides, not at their corners, and when the side of the array is reached the next number will be in the next row and at the opposite side of the array. In other words, such an array has rotated the preferred embodiment clockwise by a quarter-turn (ninety degrees).

The chart of the preferred embodiment is entirely in one-quarter of the Cartesian plane, and fills that quarter-plane to the limit of the (10,10) cell, the cell containing the number 99. All numbers are written as two digits, such as 05 instead of 5, and 00 instead of 0, so that the first digit, the tens digit, represents the x-coordinate and the second digit, the ones digit, represents the y-coordinate. The student can think of 37 in the form (x,y) as (3,7). This encourages teachers and students to investigate connections between numbers and many other areas of mathematics.

Addition using the tool is performed by counting cells upwards repeatedly for 1, and to the right repeatedly for 10. For example, 23+45=68 because the cell with 68 lies 4 to the right and 5 up from 23.

Subtraction using the tool is performed by counting cells downwards repeatedly for increments of 1, and to the left repeatedly for increments of 10. For example, 62−21=41 because the cell with 41 lies 2 to the left and 1 down from 62.

Multiplication using the tool is performed by putting together symbols. For example, CIRCLE times BLAST means 02 times 13 and the answer is 26 which is the number in the cell that has a CIRCLE and a BLAST and no other symbols.

Division using the tool is performed by taking away, or covering up, symbols. For example, if 15, for which the cell has TRIANGLE, STAR, is divided by 03, for which the cell has a TRIANGLE, the answer is the number 05 which is in the cell that has only a STAR.

Factoring using the tool is performed by observing all the symbols in a number and looking for the cells that have fewer of the same symbols. For example, 18 has CIRCLE, TRIANGLE, TRIANGLE, so its factors are 02, the CIRCLE, and 03 the TRIANGLE, and 06 which has CIRCLE, TRIANGLE, and 09 which has TRIANGLE, TRIANGLE.

Prime numbers are identified on the tool by the lack of any symbol, except the primes from 02 up to 13 which introduce the single symbols.

Fractions are examined using the tool by drawing, or visualizing, a line on the board passing through the coordinate points located in the bottom left corner of cells, and visualizing the two digit members so the first digit is the numerator and the second digit is the denominator. The line passing through the coordinate point for 12 also passes through the coordinate points for 24, 36, and 48, teaching that the fractions ½, 2/4, 3/6, and 4/8 are equal.

Exponents are demonstrated using the tool by observing cells that have two or more of a single symbol. For example, the cell for 04 has CIRCLE, CIRCLE, being the second power of 02. The cell for 81 has four TRIANGLES, being the fourth power of 03. To raise 04 to the second power, the student finds the cell that has twice what 04 has, which is 16 that has four CIRCLES.

Square roots are demonstrated using the tool by choosing a cell that has two, four or six of the same symbol, and finding the cell that has half as many of that symbol. For example, the square root of 49, which has HEPTA, HEPTA, is 07, and the square root of 81, which has four TRIANGLES, is 09 which has two TRIANGLES.

The greatest common factor of two numbers is found with the tool by noting the symbols in the cells for those numbers and finding what is common. For example, the greatest common factor of 48 and 32 is 16, because four CIRCLES are in all three cells.

The least common multiple of two numbers is found with the tool by noting the symbols in the cells for those two numbers and finding the smallest combination of those symbols. For example, the least common multiple of 04 which has CIRCLE, CIRCLE, and 06 which has CIRCLE, TRIANGLE, is 12 which has CIRCLE, CIRCLE, TRIANGLE.

Integers beyond the set shown on the tool can be explored when the students write integers in the margin outside the array of cells. To explore negative numbers, they could write −01 to the left of 09, −02 to the left of 08, and so on, ending with −10 to the left of 00. Then, for example, subtracting 17 from 13 leads the student to −04 by using the rule for subtraction that applies within the one hundred cells.

Simple algebra can be performed using the tool For example, to solve for N in the equation 4N+5=61, the student carries out the operations in the order described as reverse BEDMAS (which is a mnemonic for Brackets, Exponents, Division, Multiplication, Addition, and Subtraction, stating the order of algebraic operations). The first step in the example is to count back the 5 units, arriving at 56. The next step is to divide by 4 using the rule for division, which is to take away the symbols for 04 and that takes CIRCLE, CIRCLE away from CIRCLE, CIRCLE, CIRCLE, HEPTA, leaving CIRCLE, HEPTA, which is in the cell for 14. The solution for N is 14.

Patterns in the numbers will be memorable to students. For example, multiples of 11 are on the diagonal from 11 to 99, and multiples of 9 are on the diagonal from 09 to 99.

Measurement is learned by using the cells as a ruler, especially when the cells are one inch on a side. The perimeter and the area of a figure drawn on the board, or of an object placed on the board, can be measured by counting cells.

Geometry is made more visual by plotting Cartesian coordinates and counting cells. The Pythagorean theorem and the distance equation that follows from it are exemplified in calculations such as finding the distance from (1,4) to (4,0). In that example, the student observes there are four cells along a column and three cells along a row. The calculation of squares and square roots can then be performed as described above. Students can also use a string along the hypotenuse of any triangle as a measuring device, and then lay the string along a column, such as the 00 to 09 column, to find its length. For example, 06, 08, 10 is a Pythagorean triple, and this can be demonstrated by laying a string from the COORDINATE DOT of 06, being six cells up the column from 00, to the COORDINATE DOT of 80, being 8 cells along the row from 00, and observing that the string has a length that is 10 cells when repositioned along either a row or a column.

Graphing using the tool is accomplished by observing that the numbers in the cell, if the two digits are considered separately, are (x,y) coordinates in the first quadrant of the Cartesian coordinate plane. Students can graph points, shapes and lines, and measure slope, right on the tool. The slope is simply the number of rows up divided by the number of columns across.

Although this invention has been described in the preferred form, it should be understood that various modifications may be incorporated within the scope of the following claims.

What is claimed is:

1. A tool for teaching numbers and mathematics, comprising:
a printed array of the numbers 00 to 99, in two digit form, each in one of the one hundred cells of a square array of ten by ten square cells, with said numbers increasing in serial order from 00 in the lower left of the array up the leftmost column to 09 at the top of that leftmost column, and continuing in the next column to the right with the number 10 at the bottom of that column, and so on in serial order until the number 99 in the top rightmost cell of the array;
a set of symbols, each one of which is uniquely associated with one of the prime numbers from 02 to at least 13;
an additional single symbol that is non-uniquely associated with any prime number that does not have a symbol otherwise associated with it;
combinations of said symbols, each combination being uniquely associated with a particular non-prime number by appearing in the cell containing said particular non-prime number, said combination consisting of the symbols associated with the numbers that are all the factors of said particular non-prime number.

2. The tool according to claim 1, in which each symbol in said set of symbols has an inherent characteristic that is visually suggestive of the number with which it is associated.

3. The tool according to claim 2, in which said inherent characteristic is the shape of the symbol.

4. The tool according to claim 2, in which said inherent characteristic is the colour of the symbol.

5. The tool according to claim 1, further comprising a visible dot printed in the lower left corner of each cell.

6. The tool according to claim 1, in which each of the one hundred squares cells measures one standard unit of measurement on each side.

7. The tool according to claim 6, in which said standard unit of measurement is one inch.

8. The tool according to claim 6, in which said standard unit of measurement is one centimetre.

9. The tool according to claim 6, in which said standard unit of measurement is two centimetres.

10. The tool according to claim 1, in which said set of symbols is a set of symbols, each one of which is uniquely associated with one of the prime numbers from 02 to 11.

11. The tool according to claim 1, in which said set of symbols is a set of symbols, each one of which is uniquely associated with one of the prime numbers from 02 to 7.

12. The tool according to claim 1 in which said printed array is printed on a whiteboard suitable for erasable writing.

13. A tool for teaching numbers and mathematics, comprising:
a printed array of one hundred consecutive numbers, each in one of the one hundred cells of an array of ten cells by ten cells, with said numbers increasing consecutively starting at one corner of the array, progressing to an adjacent cell for the next number, returning after ten cells to the side of the array where lies said corner, and continuing in such a pattern until reaching the cell that is furthest away and diagonally opposite to said corner;
a set of symbols, each one of which is uniquely associated with one of the prime numbers from 2 to at least 13;
an additional single symbol that is non-uniquely associated with any prime number that does not have a symbol otherwise associated with it;
combinations of said symbols, each combination being uniquely associated with a particular non-prime number by appearing in the cell containing said particular non-prime number, said combination consisting of the symbols associated with the numbers that are all the factors of said particular non-prime number.
